(19) United States
(12) Patent Application Publication
(10) Pub. No.: US 2026/0050439 A1
(43) Pub. Date: Feb. 19, 2026

(54) EXECUTION OF INSTRUCTIONS FROM TRUSTED AND UNTRUSTED MEMORIES

(71) Applicant: XMOS LTD, Bristol (GB)

(72) Inventors: Hendrik Lambertus MULLER, Cumbria (GB); Andrew STANFORD-JASON, Bristol (GB)

(73) Assignee: XMOS LTD, Bristol (GB)

(21) Appl. No.: 19/101,124

(22) PCT Filed: Jun. 14, 2023
(86) PCT No.: PCT/EP2023/065921

§ 371 Date: Feb. 4, 2025

(30) Foreign Application Priority Data
Aug. 5, 2022 (GB) 2211430.0

(51) Int. Cl. G06F 9/30; G06F 21/57

(52) U.S. Cl. CPC G06F 9/30043; G06F 21/57

(57) ABSTRACT

A processor comprising, in the same integrated circuit or IC package: a first memory comprising one or more memory units, execution logic, a first flag, a second flag, and termination circuitry. The execution logic is arranged so as to always begin by fetching and executing a sequence of instructions from the first memory upon start-up of the processor. The first flag is hardwired to begin as asserted when the processor starts-up, and to be automatically de-asserted when the execution logic switches to executing any instruction of the sequence from any second memory instead of the first memory. The termination circuitry is hardwired to halt the execution the sequence of instructions by the execution logic if the first flag is de-asserted when the second flag is asserted.

### TECHNICAL FIELD

The present disclosure relates to a processor which has the potential to execute instructions from either a first, trusted memory or a second, untrusted memory.

### BACKGROUND

System-on-chip devices often include security algorithms. E.g. this may be an encryption algorithm (such as ECC or RSA), a hashing algorithm (such as SHA), or a key store. For instance an appliance may comprise a security module such as Trusted Platform Module (TPM), wherein the security module comprises a chip (i.e. integrated circuit, IC) configured with one or more security algorithms. E.g. the appliance may comprise a computing device such as a desktop computer, laptop, tablet, or mobile phone; or home appliance such as a television set, set-top-box, smart speaker or personal digital assistant (PDA), home stereo system, or white goods; a wearable device such as a smart watch or smart glasses; a smart home device or Internet-of-Things (IoT) device such as a smart doorbell with integrated camera, or a controller for a utility such as heating or lighting; or an onboard computer of a vehicle such as a car, truck, boat or train, etc. The appliance may be capable of communicating with another, external device over an unsecured channel. For example a laptop may be required to connect to a peripheral (e.g. keyboard, mouse, etc.) via a USB connection or local wireless network, or to a website on a server via the internet; or a home heating controller may be required to connect to a thermostat in a wired or wireless home network; or an onboard computer of a car may be required to connect to another onboard system within the car, such as the brakes, via a wired connection that could be vulnerable to tampering. In order to enable a secure connection over an otherwise insecure medium, the security module may be programmed with a secret key of the external device, stored in a secure internal storage element of the security module's chip. The external device provides a signed message (e.g. digital certificate) to the security module on the appliance via the insecure connection, and the security module authenticates the message and therefore the device based on the stored secret key. Alternatively or additionally, the security module on the appliance may sign a message based on an internally stored key of its own in order to be authenticated by the external device.

Such security algorithms may be implemented in hardware, i.e. in dedicated hardwired circuitry. Alternatively, instead of offering these algorithms as a specialised hardware block, they can also be implemented as a program using a general-purpose microprocessor, storing the program in RAM or ROM. The advantage of the implementation using a general purpose microprocessor is that it may be simpler to design and alter the software, and it may be smaller in silicon area as components are easily reused.

Furthermore, the SoC device may already have a micro-processor to perform other application specific tasks, such as decompressing images (for a set-top box), or interpreting voice commands (for a voice assistant). In that case, the same micro-processor can be shared and be used for both the application specific tasks or and the security algorithms, further saving on area.

A disadvantage of sharing the processor amongst both user tasks and security algorithms is that security algorithms add a requirement to the micro-processor to support tamperproof execution. That is, no actor inside or outside the micro-processor should reasonably be able to tamper with the execution of the program. For example, if the security algorithm is stored in RAM, then a malicious application task could modify RAM in order to modify the security algorithm and make it insecure. At a further level, an external actor could decap the device, and use electron beams to alter the contents of memory or even the structure of the device. Typically however, there is a limit to the sort of attacks that a device is protected against, and the risk of highly involved attacks (such as electron beams) may be deemed acceptable because of the costs involved.

Microprocessors typically contain mechanisms to protect software components from other software components. An example of this is a processor configured to be operable in two alternative modes, machine-mode and user-mode. In machine-mode a program can execute all instructions and instructions can execute all of memory. In user-mode only a selection of instructions and only a selection of memory are available. The selection of which portion of memory is available is set in machine-mode. Hence, if the program that runs in machine-mode is trusted, then all application programs can be “sandboxed” in user-mode and safely run in such a way that they cannot tamper with or indeed read information from the security algorithms. Typically the processor is hardwired such that the machine-mode is only available to a trusted kernel. Typically a processor will start up executing some initial boot code in machine mode, execute from a trusted source (e.g. ROM, read-only memory), which can then load a full kernel from a further source, e.g., a cryptographically signed kernel stored in external writable memory, such as flash or a hard-disk. When this happens, this kernel now executes from RAM memory, and therefore RAM is protected to avoid the kernel being compromised. A traditional mechanism for this is memory protection, where certain areas of RAM can only be seen and/or modified when in Machine mode.

A processor is typically hardwired so as upon start-up (whether for the first time or upon reset) to always begin by executing trusted boot-code from a secure memory such as ROM. This may be executed in machine-mode. The boot code can then decide if-and-when to hand over execution time to other processes from other, less secure sources such as RAM. These may be executed in user-mode. This allows a programmer to more easily sandbox the code intended to have higher level privileges.

### SUMMARY

Even when running code from a trusted source such as ROM, there are still weakness that can be exploited. An example is to exploit stack overflows: a malicious party feeds the program that runs from ROM some carefully crafted data that overwrites a bit of the stack that should not have been overwritten, and if this happens to be a saved program counter, then on function return the flow of execution may jump to RAM instead of the original ROM. The RAM could contain a malicious program, for example that would authenticate an illegitimate external device for use with the appliance in which the processor is incorporated as a security module.

Even leaving aside the possibility of malicious attacks, a lot of programs contain undiscovered bugs. Thus, execution could accidentally jump to RAM due to some unforeseen bug, even though the developer of the boot ROM had not intended this.

Another possibility can arise in a multi-threaded processor. Here it may be desired that one or more threads execute from a trusted memory such as ROM, and the other threads execute from an untrusted memory such as RAM. E.g. a trusted master thread from ROM may create or schedule one or more other threads from RAM that perform application processes. If the master thread is trusted and only ever executes from ROM then in principle there should be no problem. However it is easy for the developer to make a mistake in programming the master thread which could cause it to begin executing from an untrusted memory such as RAM, or a malicious party could find an exploit to force this, such as a stack overflow. And as another particular vulnerability in the multi-threaded case, another, untrusted application thread executing from an untrusted second memory such as RAM could try to change the state of a trusted thread by writing to the trusted thread's context registers.

It is recognized here it would be desirable to provide a “trip-wire” against unintended or malicious events which could cause execution to switch from a first, trusted memory such as ROM or a tamperproof RAM to a second, untrusted memory such as an unprotected RAM.

According to one aspect disclosed herein, there is provided a processor comprising, integrated into the same integrated circuit (IC) or IC package: a first memory comprising one or more memory units, execution logic, a first flag, a second flag, and termination circuitry. The execution logic executes a sequence of instructions, and is arranged so as to always begin by fetching and executing the sequence of instructions from the first memory upon start-up of the processor. The first flag is hardwired to begin as asserted when the processor starts-up, and to be automatically de-asserted when the execution logic switches to executing any instruction of the sequence from any second memory instead of the first memory. The termination circuitry is hardwired to halt the execution the sequence of instructions by the execution logic if the first flag is de-asserted when the second flag is asserted.

The first memory is a trusted memory, such as a ROM, OTP (one-time programmable) memory, or a tamperproof RAM. The second memory is an untrusted memory, such as an unsecured RAM or other such unsecured writable rewritable memory. The first and second memories may be said to be trusted and untrusted respectively in that the second memory has a higher risk of storing malicious code than the first memory.

The first flag indicates when the processor is operating in a trusted mode, which may be referred to herein as a “hard mode”. Hence the first flag may also be described as a “hard mode” flag or latch. When the first flag is asserted this indicates that the processor is in “hard mode”, meaning it has only ever executed instructions of the sequence from the first, trusted memory. When the first, “hard mode” flag is de-asserted, this indicates that the processor has left “hard mode” and is now in “soft mode”, i.e. an untrusted mode, meaning that at least one instruction of the executed sequence has now been executed from a second, untrusted memory. In a preferred implementation the first flag cannot be re-asserted by software. In a preferred implementation the first flag can only be re-asserted by restarting the processor.

The second flag is for setting a “tripwire” that will be triggered if the processor leaves hard mode. The second flag may be described as a “stop-on-soft” flag or latch. If it is asserted, the processor will stop (halt execution) as soon as the processor leaves hard mode and enters soft mode. The second flag may be hardwired to begin as de-asserted upon start-up of the processor, and to be assertable by software fetched only from the first memory. In this case, preferably the second flag cannot be de-asserted by software. Preferably the second flag can only be de-asserted by restarting the processor. In alternative implementations however, the second flag could be hardwired to begin as asserted upon start-up of the processor and to be de-assertable by software fetched only from the first memory. In this case the second flag may be configured such that it cannot be asserted by software, and preferably can only be re-asserted by restarting the processor.

In embodiments, the execution logic may comprise respective hardware support for each of a plurality of threads, the respective hardware support comprising at least a respective context arranged to represent a program state of a respective thread, said sequence of instructions being a first one of the threads.

In such embodiments the execution logic may comprise a common execution unit for the threads, and interleaving circuitry operable to interleave the threads through the common execution unit. Alternatively, the execution logic may comprise a plurality of execution units each operable to execute a respective one of the threads. A combination of these approaches is also possible.

Either way, in some multi-threaded embodiments, the processor may comprise a respective instance of the first flag and a respective instance of the second flag associated with each context. The termination circuitry may be configured so as, if any context has the respective first flag de-asserted when the respective second flag is asserted, to automatically halt execution of the respective thread represented by the respective context.

In some cases, the termination circuitry may be configured so as: when the thread of a first of said contexts, that has the respective first flag de-asserted, modifies a state of the thread represented by a second of said contexts that has the respective first flag asserted, to automatically de-assert the respective first flag of the second context.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a processor in accordance with embodiments disclosed herein,

FIG. 2 is a schematic block diagram showing an example of a multi-threaded processor in accordance with embodiments disclosed herein, and

FIG. 3 is a schematic block diagram showing one example of a circuit for halting execution in accordance with embodiments disclosed herein.

### DETAILED DESCRIPTION OF EMBODIMENTS

The present disclosure describes a processor which supports the use of a “hard-mode”. Hard-mode is a mode in which the processor may be treated as if it was a piece of hardware, that is, a piece of silicon that is tamper-proof and built out of gates. In embodiments, when in hard mode the processor may have privileges as if it was a piece of hardware. For example, the processor may be able to access a key-store stored in a special section of trusted memory; it may be able to generate random numbers for software to use (and the software can trust the numbers to be truly random and not be hijacked by somebody to generate a fixed sequence), or the software may be able to calculate a hash (e.g. SHA2) of a piece of memory.

The device has a trusted, on-chip memory, e.g. ROM, which is tamper-proof as it is contained on the same silicon, and from which execution always begins upon start-up. Hard-mode is always enabled when the processor starts up, and hard-mode will be disabled when certain conditions are no longer met. In the preferred implementation, the only way for hard-mode to be enabled is through a chip reset. So once the processor has left hard-mode it is no longer acting as if it was a piece of hardware. An additional stop-on-soft flag can be set to indicate that the processor should stop when hard-mode has been disabled.

For a multi-threaded chip, each thread may be provided with its own hard-mode flag and stop-on-soft flag. On reset, one or more threads are automatically started, and these threads have both flags set; that is, all threads that start on reset are in hard-mode and the thread will be stopped when hard-mode is disabled.

To implement the above, the processor may comprise hardware added to the execution pipe that:
disables hard-mode when an instruction is fetched from any other location (e.g. RAM, flash, etc) than the internal trusted memory (e.g. ROM or OTP memory);
stops the thread from issuing instructions when stop-on-soft is set and hard-mode is cleared; and
in a multi-threaded case, preferably when thread X modifies state in thread Y through any mechanism that the processor may support then:
   if thread Y has hard-mode set, and thread X has hard-mode cleared, then hard-mode will be cleared in thread Y (and by inference, if thread Y had stop-on-soft set thread Y will stop).
This protects thread Y from interference by thread X.

When the processor comes out of reset, then one or more hardware threads will be started (by the process of the processor leaving reset) that will all have hard-mode set and stop-on-soft cleared by the reset hardware. If a thread wants to execute normal application software, it can leave the stop-on-soft bit cleared, and it will ignore hard-mode. If on the other hand the thread will execute secure software, it will set the stop-on-soft bit (e.g. as one of its first operations upon start-up), and then it can run security algorithms from ROM only (or other such trusted memory). That is, the secure component in this multi-threaded processor is tamper-proof, because all instructions are fetched from ROM. If somebody tries to tamper with the processor and tries to get the security thread to execute from RAM, it will automatically trip the hard-mode bit and stop the secure software. Stopping is preferable to executing bad code.

In a multi-threaded scenario, the hard-mode feature enables a multi-threaded processor to share the processor core between secure software, whilst the secure software is to all intents and purposes a tamper-proof hardware implementation. Particularly, it allows a tamper-proof secure module to be implemented on one of the hardware threads, whilst other hardware threads execute application software as normal.

RAM may be protected using a conventional protection mechanism such as paging or segmentation. Any other resources that can be shared amongst threads on the processor may also be protected in a conventional way.

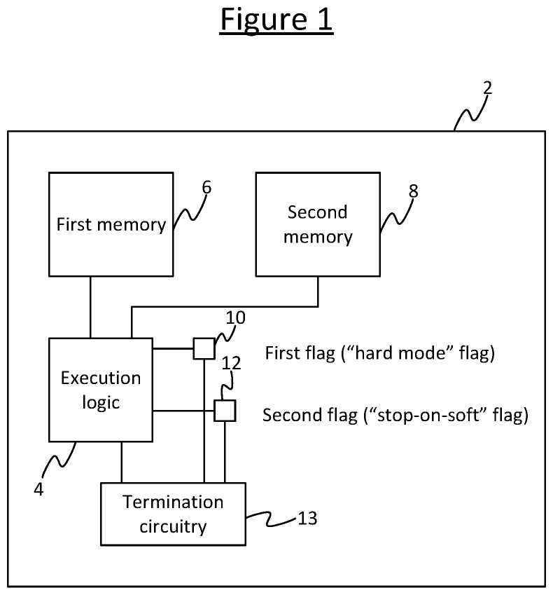

FIG. 1 gives a schematic block diagram of a processor 2 in accordance with embodiments of the present disclosure. The processor 2 comprises: execution logic 4, first memory 6, a first flag 10, a second flag 12, and termination circuitry 13. These components 4, 6, 10, 12, 13, are all incorporated into the same integrated circuit (IC), i.e. the same semiconductor die. Alternatively, though less preferred for security purposes, they could be implemented on two or more different die sealed within the same IC package. Either way, the components 4, 6, 10, 12, 13 are thus made physically inaccessible, except via any pins of the IC package. Particularly, the internal connections between the components 4, 6, 10, 12, 13 are not physically accessible.

The processor 2 may be incorporated in an appliance, such as any of the appliances described in the background section. E.g. the appliance could be a home appliance, smart device, computer device, or wearable device, etc. The processor 2 may be comprised by a security module, e.g. a TPM, for use in any such an appliance. The appliance or security module may be configured with any of the functionality described in the background section or for any of the use cases described in the background section. For example, in embodiments the appliance be configured to establish a secure connection between the appliance and an external device via an untrusted medium, and the processor 2 may be comprised by a security module of the appliance which is responsible for authenticating the external device for the purpose of communicating with the appliance over the untrusted medium. The external device could be, for instance, another device on the same local wired or wireless network (e.g. network of smart devices in a home network), or another network device on a wide area network or internetwork such as the Internet (e.g. a web service), or another component in the internal network of a vehicle. The intrusted medium may comprise a wired or wireless medium, which may comprise a local or wide area network or a direct one-to-one connection.

Within the processor 2, the execution logic 4 comprises one or more execution units, i.e. execution hardware for executing machine code instructions. Instructions as referred to herein mean machine code instructions, i.e. instances of the instruction types defined in the fundamental instruction set which the execution logic 4 is configured to execute, each instruction type being defined by a respective opcode and zero or more operand fields, depending on the instruction type. The execution logic 4 is operatively coupled to the first memory 6, and is arranged so as to automatically begin by executing a sequence of instructions from the first memory upon start-up of the processor 2 (where start-up herein could mean powering up the processor 2 for the first time or resetting the processor). The execution logic 4 is hardwired with this behaviour, i.e. configured in fixed-function hardware circuitry of the execution logic to begin execution from the first memory 6. Depending on embodiment, the sequence of instructions in question could be a thread of a multithreaded processor or the sole sequence of instructions in a non-multithreaded processor.

The first memory 6 may comprise one or more memory units employing one or more memory media. The first memory 6 is a memory that is trusted. For example, it may consist of ROM (read only memory), OTP (one time programmable) memory, and/or a tamperproof writeable memory such as a tamperproof RAM (random access memory). Preferably the first memory 6 is only of a type whereby writes are physically prevented in some way. This could either be a memory which simply comprises no mechanism for writing data after manufacture, as in a ROM; or a tamperproof writable memory, which for the present purposes means that the memory does include a mechanism for writing but that mechanism can be physically disabled. For example, one could use a write-once memory such as an OTP (one time programmable) memory, eFuses (silicon fuses), or PROM; but in all these cases even though they are write-once memories, it is still possible to write extra bits. E.g. a write-once memory typically starts with all 0x00000000, and then the programmer sets the bits they want set; the memory is write-once in that bits cannot be reset. But it is not write-once in that extra bits cannot be set at a later stage. So if a write-“once” memory is used for the first memory 6, the write function should be disabled such as by a setting a bit in the write-once memory that disables writing. Similarly, one could use on-chip FLASH or MRAM, which are fast-read, slow-write, as long as is the write line is disabled using a suitable mechanism.

The execution logic 4 is also operatively coupled to a second memory 8. The second memory 8 may comprise one or more memory units employing one or more memory media. The second memory 8 may be internal to the processor 2 (integrated on the same IC or sealed with the same IC package as the other components 4, 6, 10, 12) or alternatively could be external (e.g. connected on the same circuit board, or within the same housing of an appliance in which the processor 2 is included, or even external to the housing of the appliance), or a combination of internal and external. The execution logic 4 is capable of fetching and executing instructions from the second memory 8. However, it may not always be desirable for it to be allowed to do so.

The second memory 8 represents any other memory than the trusted first memory 6. The second memory 8 is not trusted. For example the second memory may comprise RAM or EEPROM, which may be unprotected (not tamperproof). The first memory 6 is trusted while the second memory 8 is untrusted. This means that, to a degree of risk determined tolerable by the designer for the application in question, the content of the first memory 6 is deemed immutable whereas the content of the second memory 8 is vulnerable to being changed (either because it is intended to be rewritten or because it is more vulnerable to malicious processes than the first memory 6). The first memory 6 may be a memory that can physically only be written once and then not again, such as ROM memory; whereas the second memory 8 may comprise rewriteable memory such as RAM or EEPROM. Alternatively or additionally, the first memory 6 may be a memory that is physically protected from alteration such as by being embedded in the IC or package of the processor 2, or within a sealed housing of the appliance in which the processor 2 is included, wherein no external connection is provided to enable externally addressing and rewriting the first memory 6; whereas the second memory 8 may be externally accessible for rewriting. Alternatively or additionally, the first memory 6 may be a secure memory or area of memory having a hardware or software security mechanism, such as encryption or password protection, restricting access to the memory for the purpose of writing or rewriting; whereas the second the second memory 8 may be an unsecured memory or area or memory. In some such embodiments the second memory 8 could even be an unsecured area in the same physical memory unit as an area of secure memory used for the first memory 6. In embodiments, the content of the first memory 6 is fixed at the time of manufacture, whereas the second memory 8 is made accessible for writing to by application developers.

In accordance with the present disclosure, the processor 2 comprises a special flag in the form of the first flag 10, which may also be referred to herein as the “hard mode”flag. When set (i.e. asserted), this indicates that processor 2 is operating in a trusted mode, which may be referred to herein as a “hard mode”. For the present purposes this means that the processor 2 so far, since the last start-up or reset, has only ever executed instructions of the executed sequence from the first memory 6 and never any other, second memory 8. The sequence in question could be a particular thread (or rather the thread executing from a particular context) in a multi-threaded case, or the sole sequence of execution in a non-multithreaded case. The processor 2 is hardwired (i.e. configured in fixed function circuitry) so as to automatically clear (i.e. de-assert) the first flag 10 as soon as the processor leaves hard mode and enters “soft mode” for the executed sequence, i.e. as soon as the execution logic begins fetching instructions of the executed sequence from the second mode.

When the first, “hard mode” flag is de-asserted, this indicates that the processor has left “hard mode” and is now in “soft mode”, i.e. an untrusted mode, meaning that at least one instruction of the executed sequence has now been executed from a second, untrusted memory.

The hard mode flag 10 may be implemented as a flip-flop or latch in the circuitry of the processor 2. It only requires a single bit, though work-arounds that use additional, redundant bits are not excluded. Preferably the hard mode flag 10 cannot be reset (i.e. re-asserted) by software. I.e. the way it is configured in hardware does not include a mechanism enabling any instruction of the instruction set of the processor 2 to de-assert the hard-mode flag 10. The hard-mode flag 10 cannot be set by software-no mechanism for enabling this is provided on the processor 2. Preferably the hard mode flag 10 can only be reset by restarting the processor 2, which also causes the execution logic 4 to automatically begin executing the starting instructions of the sequence from the trusted first memory 6 (e.g. ROM) again. In embodiments the hard mode flag 10 also cannot be cleared by software, though this is less critical since clearing the hard mode in any case indicates that the processor is not running in an untrusted mode.

When the processor 2 is in the hard mode, it can be treated as if the functionality of the executed sequence of instructions was implemented in gates of fixed-function hardware circuitry, in that the functionality can be treated as immutable (within some reasonable degree of risk, short of decapping attacks or the like).

Optionally, in embodiments, the hard mode flag may be readable by software, either the software running internally on the execution logic 4 of the processor 2 itself, and/or by software running on an external computer. This enables the software to check whether the processor 2 is in the trusted hard mode, and hence whether the processor 2 can currently be trusted.

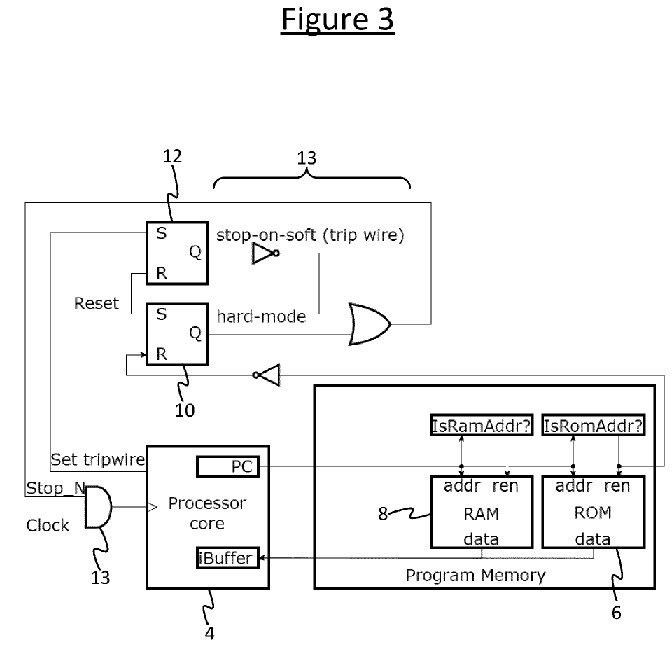

The second flag 12 may be described as a “stop-on-soft” flag. When set (i.e. asserted), it sets a “tripwire” that will be triggered when hard mode is disabled. The termination circuitry 13 is configured so as, if the second flag 12 is set, to physically halt the execution of the sequence of instructions as soon as the processor leaves hard mode and enters soft mode, as indicated by the first (hard mode) flag 10, i.e. as soon as the execution logic 4 attempts to start fetching any instruction of the sequence for execution from the second memory 8 (which represents any memory other than the one or more memory units of the trusted first memory 6). An example of circuitry for halting execution will be discussed shortly in relation to FIG. 3.

The stop-on soft flag 12 may be implemented as a flip-flop or latch in the circuitry of the processor 2. It only requires a single bit, though work-arounds that use additional, redundant bits are not excluded. Unlike the hard-mode flag 10, the stop-on-soft flag 12 can be controlled (at least to some extent) by software. However, in a preferred implementation it can only be asserted and not de-asserted by software, and this can only be done by software executed form the first memory 6 whilst it is still in hard mode.

In the preferred implementation the stop-on-soft flag 10 is hardwired (i.e. configured in fixed-function circuitry) so as to always begin as cleared when the processor 2 starts up (whether for the first time or upon reset). Software executing from the first memory 6 can then set the stop-on-soft flag 12, but preferably no software can clear the stop-on-soft flag—no mechanism for this is provided on the processor 2. Thus the developer of the trusted boot code can decide whether or not to set the tripwire. However once the tripwire is set, it cannot be turned off without restarting the processor 2 (which would cause it to start again executing code again from the trusted first memory 6). Thus execution cannot be resumed without resetting (restarting) the processor 2. In embodiments can only be done by a hard reset, not a soft reset triggered by software.

In embodiments, the stop-on-soft flag 12 can only be set by executing an instance of a special dedicated instruction in the instruction set of the execution logic 4, not a general purpose PUT instruction. In this case the execution logic 4 is configured so as, when the dedicated instruction type is executed, to check that the instruction has been fetched from the first memory 6 and to only respond by setting the stop-on-soft flag 12 on condition of this.

In a less preferred implementation, the stop-on-soft flag 10 is hardwired so as to always begin as set when the processor 2 starts up, and software executing only from the first memory 6 can then clear the stop-on-soft flag 12. This means the developer of the trusted boot code can choose not to use the tripwire for a given application. However this implementation may be less preferred since allowing software to clear the tripwire may be considered a security issue.

On a point of terminology, the terms “hard mode” flag and “stop-on-soft” flag will be used herein as a convenient description of their functionality, but these terms could equally be replaced with “first flag” and “second flag” respectively. Note also that terms such as “assert”, “set”, “de-assert” and “clear” do not limit to whether an asserted (set) state is represented as a binary 1 or 0 and vice versa whether a de-asserted (cleared) state as represented as a binary 0 or 1, or indeed whether the states are represented in some other form. Nor do they limit to the asserted state of the first flag 10 necessarily being represented in the same way as the asserted state of the second flag 12, nor the de-asserted state of the first flag 10 necessarily being represented in the same way as the de-asserted state of the second flag 12. E.g. while in embodiments the asserted state of both flags could be represented as a binary 1 or both as a binary 0, in other implementations it is possible that the asserted state of the first flag 10 could be represented as a binary 1 while the asserted state of the second flag 12 could be represented as a binary 0 or vice versa. The use of the terms “asserted” or “set” in relation to the first flag 10, i.e. the hard mode flag, is merely a convenient terminology to refer to the fact, at the functional level, that the processor 2 is positively in the hard or trusted mode, i.e. can still be said in the affirmative to have so far (since last start-up or reset) only executed the sequence of instructions in question from the first, trusted memory 10. Similarly the use of the term “asserted” or “set” in relation to the second flag 12, i.e. stop-on-soft flag, is merely used to describe positively or in the affirmative that at the functional level the stop-on-soft “tripwire” is set. The terms “asserted” or “set” could equally be replaced with “first state”, and the terms “de-asserted” or “cleared”could equally be replaced with “second state”.

In a multithreaded case, in some embodiments there may just be provided a single hard mode flag 10 for all threads, such that all threads are trusted or untrusted together. In this case there may be provided a respective stop-on-soft flag 12 per thread (or rather per context), such that the tripwire can be set individually for each thread, or there may be provided a single stop-on-soft flag 12 for all threads, such that all threads will be tripped together if set.

In further alternatives there may be provided be a respective hard-mode flag 10 and a respective stop-on-soft flag 12 per thread (or rather per context), for each of one or more threads. This means that each thread can be individually trusted or non-trusted. In some embodiments there could just be provided a hard-mode flag 10 and stop-on-soft flag 12 for only a single thread, e.g. a single master thread that begins executing on start up and which can choose whether and when to launch other, unprotected threads. More preferably however, there is provided an individual a respective hard-mode flag 10 and an individual respective stop-on-soft flag 12 for each of some or all threads which the processor 2 can execute concurrently or in parallel, i.e. one for each context. This allows the tripwire to be set and evaluated individually for each thread.

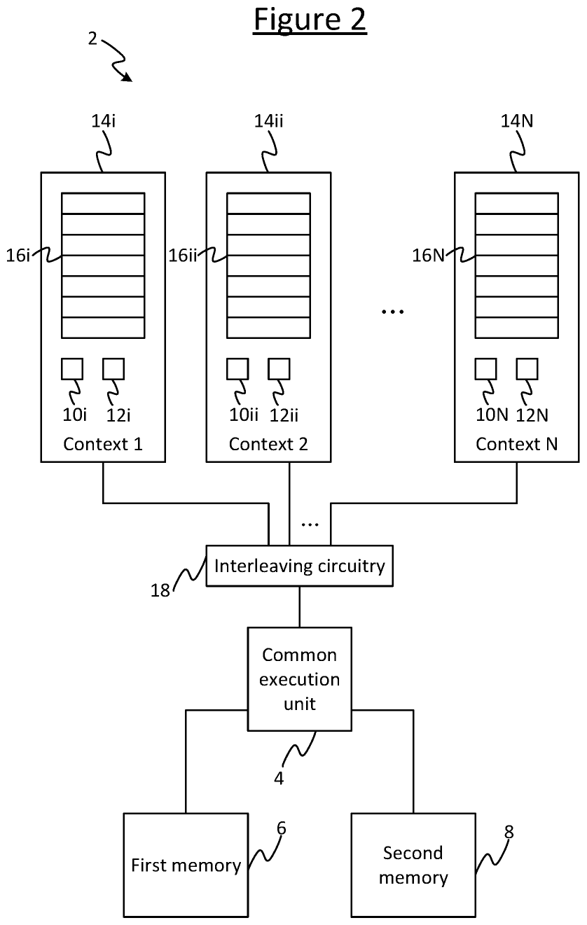

FIG. 2 shows a multi-threaded implementation of the processor 2. Here, the processor 2 comprises respective hardware support for each of a plural number N of threads, where N is at least two. The hardware support for each thread comprises at least a respective context 14n (n=i, ii, . . . N), where each context comprises a respective set of registers 16n. Each respective register set 16n comprises a respective program counter (PC) arranged to record the current program count of the respective thread, and a respective set of operands arranged to hold operands being worked on by the respective thread. Caching and/or buffering of instructions may be included (e.g. on a per thread basis), but for simplicity these are not shown here. Any caching or buffering of instructions should respect and update the relevant flags 10, 12 as appropriate. Optionally the respective registers 16n of the respective context 14n may also comprises one or more respective status or control registers of the respective thread, such as a flag for pausing the respective thread.

A thread is a sequence of instructions to be executed from memory, in the present case from the first and/or second memories 6, 8. A context 14 is a piece of hardware in the form of registers arranged to represent the program state (program count, current operands and any other status or control state) of a respective thread when allocated to the respective context 14n. Note that there is not necessarily a one-to-one mapping between threads stored in program memory 6, 8 and contexts 14: different threads could be allocated to run using a given context 14n at different times, and/or not all contexts 14i. N necessarily have threads allocated to them at all times. When a thread is allocated to a given context 14n, its program state is held in the registers 16n of the respective context 14n and the execution logic 4 executes the thread using the program state in the respective context 14n to which the thread is allocated. This will include fetching instructions from a location in memory 6, 8 defined by the respective program counter, holding loaded operand data and results of operations in the respective operand registers. It may also include affecting the execution based on status or control information held in the registers 16n of the respective context 14n, such as pausing execution of a thread flagged as paused in its respective context 14n.

There are at least two ways that a multi-threaded processor can be designed. In embodiments, as shown in FIG. 2, the execution logic 4 comprises a single or common execution unit shared among the plurality of contexts 14i. N. The processor 2 also comprises interleaving circuitry 18 operable to interleave the instructions of the threads allocated to the different contexts 14i. N through the execution unit 4, e.g. according to a round-robin schedule (which could be a weighted round-robin schedule). This is sometimes referred to as barrel threading, and the interleaved threads may be said to be executed concurrently. The interleaving schedule may be determined in hardware by the interleaving circuitry 18, or alternatively the interleaving circuitry 18 could just comprise simple switching circuitry that can be controlled by software (e.g. one of the threads or an operating system running on the execution unit 4) to interleave the threads according to a schedule determined by the software.

In an alternative design of the multi-threaded processor 2, the execution logic 4 may comprise a respective execution unit associated with each context 14n. In this case the hardware support for each (allocated) thread comprises the respective execution unit. In this case no interleaving is required and the threads allocated to the different contexts 14i. N can execute simultaneously with one another. This may be described as true parallelism, as opposed to concurrent execution by interleaving. A combination of the two designs is also possible, i.e. the execution logic 4 may comprise a plurality of parallel execution units whereby respective subset of two or more threads may be interleaved through each of one or more of the execution units.

In either the interleaved or parallel design (or any other multi-threaded design), according to embodiments disclosed herein, the respective hardware support for at least one thread comprises a respective instance of the hard mode flag 10n and a respective instance of the stop-on-soft flag 12n. This means that the hard mode, and the tripwire set by the stop-on-soft flag, may be set specifically for the thread whose program state is represented by the respective context 14n (not for other threads or contexts). In this case, the termination circuitry 13 is configured so as if the hard-mode flag 10 is cleared when the stop-on-soft flag is set, to halt execution of the respective thread allocated to the respective context 14n. In embodiments that context then cannot be used again until the processor 2 is reset. In other words, until the processor 2 is restarted, no thread can now be executed using the context 14 in which the hard mode flag is cleared and the stop-on soft flag is set. In embodiments one or more other threads allocated to one or more other contexts 14 may be allowed to continue executing. Alternatively the whole processor 2 may be stopped if the tripwire trips, and the processor may need to be reset when any tripwire trips.

Preferably, the respective hardware support for each respective thread comprises a respective instance of the hard mode flag 10n and a respective instance of the stop-on-soft flag 12n. This may be considered as part of the respective context 14n for the thread. In such embodiments, this means that the hard mode, and the tripwire set by the stop-on-soft flag, may be set independently for each context 14n, and therefore for the respective thread allocated to each context. In other words, the termination circuitry 13 is configured so as if the respective hard-mode flag 10 of any context 14n is cleared when the respective stop-on-soft flag 12 is set, then then it will automatically halt execution of the respective thread represented by the respective context.

As for what happens with the other threads running from the other contexts 14 when the tripwire in one context 14n is triggered, there are at least two possible implementations. In a lenient implementation, when one of the threads allocated to one of the contexts 14n is halted due to the respective hard mode flag 10 is cleared when the respective stop-on-soft flag is set, then the termination circuitry 13 will allow execution of one, some or all other of the threads that are allocated to one, some or all of the other contexts 14 to continue executing. In a strict implementation on the other hand, the termination circuitry 13 will halt execution across all contexts 14i . . . N.

In a preferred implementation, the processor 2 is configured such that when it starts up (whether for the first time or upon reset), the hard mode flag 10 for each context 14n will begin as set (asserted) and the stop-on-soft flag 12 for each thread will begin as cleared. If a thread is to execute software from the second memory 8 (e.g. application software), it can leave the stop-on-soft bit cleared, so that it leaving hard-mode will not trip the trip wire. If on the other hand the developer wishes the thread to execute software only from the first memory 6 (e.g. secure executive software such as a kernel, or a supervisor thread or other such master thread), then that thread will be programmed to set the stop-on-soft bit (e.g. as one of its first operations upon start-up), such that if it subsequently leaves hard mode, the tripwire will be triggered. Preferably no stop-on soft flag 12, for any thread, can be cleared by software. In alternative implementations however, it is possible instead that the stop-on-soft flag 12 for each thread will begin as set upon start-up. In that case if a thread is to execute software from the second memory 8 (e.g. application software), it will be programmed to clear the flag, but if it is to execute software only from the first memory 6 then the thread will leave the stop-on-soft flag set.

In embodiments, if a new thread is allocated to a context that has had its stop-on-soft flag 12 set, then the new thread will inherit the values of the stop-on-soft and hard-flags 10, 12. In one implementation the processor 2 may only start one of the threads initially, and that thread then dynamically starts other threads, and they will inherit the existing values of the flags 10, 12.

In embodiments, when thread X modifies state in thread Y through any mechanism that the processor may support then: if thread Y has hard-mode set, and thread X has hard-mode cleared, then hard-mode will be cleared in thread Y, meaning that if thread Y had stop-on-soft set thread Y will stop). This protects thread Y from interference by thread X.

In other words, when the thread allocated to a first of said contexts (e.g. 14i), that has the respective hard mode flag 10i cleared, modifies a state of the thread allocated to a second of said contexts (e.g. 14ii) that has the respective hard mode flag 10ii set, the termination circuitry 13 will automatically clear the respective hard mode flag 10ii of the second context 14ii. The state being modified could be e.g. the program counter, an operand value in an operand register, or thread status or control state. It will be appreciated that “first” and “second” as used herein are just arbitrary labels, and do not necessarily imply an order of creation or execution or such like.

In addition to the above features, in embodiments the processor 2 may be configured so that hard-mode and stop-on-soft get inherited by new threads that are started. That is, when a new thread X is created by thread Y, then: if thread Y has hard-mode set, then thread X will have hard-mode set, but otherwise hard-mode will be cleared in thread X. Preferably also, if thread Y has hard-mode set and stop-on-soft set, then thread X will have stop-on-soft set, otherwise stop-on-soft will be cleared on thread X.

In other words, when an existing one of said threads (running from a first context, e.g. 14i) creates a new one of said threads (newly allocated to another context, e.g. 14ii), then: if the context of the existing thread has the respective hard mode flag 10i set, then the new thread will begin with the respective hard mode flag 10ii asserted, but otherwise the respective hard mode flag 10ii of the new thread will be cleared. Preferably also, if the existing thread's context has the respective hard mode flag 10i asserted and the respective stop-on-soft flag 12i asserted, then the new thread will have the respective stop-on-soft flag 12ii asserted in its respective context, but otherwise the respective stop-on-soft flag of the new thread will begin as cleared.

As the state of the hard-mode flag 10 and preferably stop-on-soft flag 12 get inherited when new threads are created, any thread that is in hard-mode can be confident that its state can be traced back through instructions from the trusted internal first memory 6 (e.g. ROM) all the way back to the point at which the processor came out of reset. The software may have made decisions based on data it has seen (e.g. from RAM or on external I/O pins), but it was software in the first memory 6 (e.g. ROM) that made those decisions.

According to an example use case, the processor 2 may be programmed with a plurality of threads, wherein the entirety of at least one thread stored in the first memory 6 (e.g. ROM) whereas at least part of at least one other thread is stored in the second memory 8 (e.g. RAM). In this case, the thread (or at least one of the threads) stored in, and executed from the first memory 6 may be intended to remain as a trusted thread that only ever executes from the first memory 6. Therefore in accordance with the teachings herein, this thread may have its respective stop-on-soft flag (e.g. 12i) set, such that it will trip the termination circuitry 13 and therefore halt if it ever attempts to execute any instruction from the second memory 8. On the other hand for one or more other threads, at least part of the thread may comprise code from the second memory 8 and the respective stop-on-soft flag (e.g. 12ii) may not be set. I.e. the respective tripwire may be disabled for this or these threads.

For instance, the trusted thread with the stop-on-soft flag 12i set could comprise a trusted kernel or supervisor thread, or other such master thread, that is responsible for creating and/or scheduling other threads, some of which may comprise application processes which run from the second, untrusted memory 8 and do not have the respective stop-on-soft flag 12ii set.

Hard-mode could also be used on a single-threaded implementation of the processor 2. In some such embodiments the processor 2 may to allow hard-mode to be swapped in and out by the O/S (operating system) swapping tasks, so hard-mode would be a user-mode feature only which relies on trusting the O/S.

In another example use case which could apply to a single or multi-threaded processor, different variants of the processor 2 may be supplied to different parties, to the same party for different application purposes. One or more instances of a first variant of the processor 2 may be produced with first software version in the first memory 6, e.g. a first ROM image, while one or more instances of a second variant of the processor 2 may be produced with a second software version in the first memory 6, e.g. a second ROM image. The first version of the software may be configured such that the stop-on-soft flag 12 (of at least one thread in the multi-threaded case) will be set, whereas the second version of the software may be configured such that the stop-on-soft flag 12 will not be set (potentially will not be set for any threads in the multithreaded case, or perhaps for fewer threads than in the first version). In such use cases, the hard mode and stop-on-soft flags 10, 12 provide a flexible way for a manufacturer, designer or supplier way to use the same basic silicon design to provide processors 2 with different security levels for different purposes and/or to different parties.

In further alternative or additional embodiments, hard mode could also be automatically switched off when data is loaded from or stored to the second memory 8, e.g. an unprotected area of RAM. This could be used to disable the processor 2 in the single-threaded (non-multi-threaded) case, or on a per context basis in the multi-threaded case. However this is not essential since if the sequence of i executing from the trusted first memory 6 can be trusted, then it may be trusted not to load data from or store data to any untrusted location. Or in another variant, the secure software from the first memory 6 (e.g. ROM) may be allowed to write to the second memory 8 (e.g. RAM) without leaving hard mode, but if the secure software attempts to read from the second memory 8 then this will cause leaving hard mode (thus tripping a stop if the stop-on soft flag is also set).

Note that generally, any data storage location referred to herein could be an area of the same memory unit or units of the first and/or second memories 6, 8 as used to store the program code, or a separate data memory, or a combination.

Also, while reference is made herein to stopping or halting execution when a tripwire is tripped (i.e. when hard mode flag 10 is de-asserted while the stop-on-soft flag 12 is asserted), in embodiments this does not exclude that the processor 2 could be automatically restarted when tripped. Stopping or halting execution means the current sequence of instructions is stopped or halted, and the processor may then require an explicit (e.g. manual) restart signal in order to restart or could be triggered by the tripwire to automatically restart.

FIG. 3 shows one example of circuitry 13 for stopping execution by disabling the clock. It will be appreciated that this is just one example and there are a multitude of solutions the skilled person could devise once given the idea of the functionality disclosed herein.

In the example of FIG. 3, there are shown two one-bit flags implementing the hard-mode flag 10 and stop-on-soft flag 12. These are shown in context of the first and memory spaces 6,8, along with a reset signal and a stop condition. The reset signal that may or may not come from power-on-reset.

The flags are implemented by two SR (set-reset) flip flops (clocks not shown), one that contains the hard-mode bit, one the stop-on-soft bit. The PC from the processor drives memory to load data into the instruction-buffer (iBuffer), which in this example it can load from RAM 8 and ROM 6. If it is not ROM, the hard-mode flip-flop 10 is reset. The stop-on-soft flop 12 is reset to 0 on start-up. The OR gate will initially be high on both legs, and if both legs drop to zero (because both the stop-on-soft trip wire is set to 1 and the hard-mode is reset to 0, then the STOP_N wire (_N means not) goes to 0 indicating that the processor should stop. This can be achieved by, for example, using it to gate the clock which clocks execution by the execution logic 4.

It will be appreciated that the above embodiments have been described by way of example only.

More generally, according to the present disclosure there is provided a processor comprising, integrated into a same integrated circuit, IC, or IC package: a first memory comprising one or more memory units; execution logic for executing a sequence of instructions, the execution logic being arranged so as to always begin by fetching and executing the sequence of instructions from the first memory upon start-up of the processor; a first flag hardwired to begin as asserted when the processor starts-up and to be automatically de-asserted when the execution logic switches to executing any instruction of the sequence from any second memory instead of the first memory; a second flag; and termination circuitry hardwired to halt the execution the sequence of instructions by the execution logic if the first flag is de-asserted when the second flag is asserted.

In embodiments, the first flag may be arranged such that it cannot be re-asserted by software.

In embodiments, the first flag may be arranged such that it can only be re-asserted by restarting the processor.

In embodiments, the second flag may be hardwired to begin as de-asserted upon start-up of the processor and to be assertable by software fetched only from the first memory when the first flag is asserted. In some such embodiments, the second flag may be arranged such that it cannot be de-asserted by software. The second flag may be arranged such that it can only be de-asserted by re-starting the processor.

The execution logic is configured to execute machine code instructions being instances of instruction types in a predefined instruction set of the processor. In embodiments the instruction set may include a dedicated instruction for asserting the second flag, the dedicated instruction being only available when executing instructions from the first memory and being the only way to assert the second flag.

In embodiments, the execution logic may comprise respective hardware support for each of a plurality of threads, the respective hardware support comprising at least a respective context arranged to represent a program state of a respective thread, said sequence of instructions being a first one of the threads.

In embodiments, the execution logic may comprise a common execution unit for the threads, and interleaving circuitry operable to interleave the threads through the common execution unit.

In embodiments, the execution logic may comprise a plurality of execution units each operable to execute a respective one of the threads.

In embodiments, the processor may comprise a respective instance of the first flag and a respective instance of the second flag associated with each context; and the termination circuitry may be configured so as, if any context has the respective first flag de-asserted when the respective second flag is asserted, to automatically halt execution of the respective thread represented by the respective context.

In embodiments, the termination circuitry may be configured so as: when the thread of a first of said contexts, that has the respective first flag de-asserted, modifies a state of the thread represented by a second of said contexts that has the respective first flag asserted, to automatically de-assert the respective first flag of the second context.

In embodiments, the termination circuitry may be configured so as when one of the threads is halted due to the respective first flag being de-asserted when the respective second flag is asserted, to allow execution of one, some or all other of the threads to continue.

Alternatively, in embodiments, the termination circuitry may be configured so as when any of the threads is halted due to the respective first flag being de-asserted when the respective second flag is asserted, all execution across the whole processor is halted.

In embodiments, the processor may be programmed with the plurality of threads but only one or some, but not all, of the threads are programmed to assert the respective second flag.

In embodiments, the processor may be configured such that when an existing one of said threads creates a new one of said threads, then: if the existing thread has the respective first flag asserted then the new thread will begin with its respective first flag asserted, but otherwise the respective first flag of the new thread will be de-asserted.

In embodiments, the processor of may be configured such that: if the existing thread has the respective first flag asserted and the respective second flag asserted, then the new thread will have its respective second flag asserted, but otherwise the respective second flag of the new thread will begin de-asserted.

In embodiments, the first flag may be arranged to be readable by software.

In embodiments, the first memory may consist of ROM, OTP memory, tamperproof RAM and/or other tamperproof rewriteable memory.

In embodiments, the second memory may comprise RAM, EEPROM or other rewriteable memory.

In embodiments, the first memory may comprise a protected area of rewriteable memory in a memory unit and the second memory comprises an unprotected area of rewritable memory in the same memory unit.

In embodiments the first flag may be hardwired so as: to be automatically de-asserted if an instruction of the sequence loads data from an untrusted memory or area of memory.

Alternatively or additionally, the first flag may be hardwired so as: to be automatically de-asserted if an instruction of the sequence stores data to an untrusted memory or area of memory.

In embodiments, the termination circuitry may be configured to perform said halting of execution by gating a clock that clocks the execution.

According to another aspect of the present disclosure, there may be provided an appliance comprising the processor of any embodiment disclosed herein.

In embodiments, the processor may store a first secret key and may be programmed to authenticate, based on the first secret key, an external device external to the appliance communicating with the appliance over an insecure channel. Alternatively or additionally, the processor may store a second secret key and may be programmed to sign a message with the second secret key in order to be authenticated by the external device.

In embodiments, the appliance may comprise comprising multiple instances of the processor each with a different key, arranged such that when execution on any one of the instances of the processor is halted then the appliance is disabled.

According to another aspect of the present disclosure, there may be provided a method comprising providing different instances of the processor or appliance of any embodiment disclosed herein, wherein on one of the instances of the processor one or more of the instructions fetched from the first memory are programmed to assert the second flag, and in another of the instances of the processor no instructions are programmed to assert the second flag.

Other variants or use cases of the disclosed techniques may become apparent to the person skilled in the art once given the disclosure herein. The scope of the disclosure is not limited by the described embodiments but only by the accompanying claims.

1. A processor comprising, integrated into a same integrated circuit, IC, or IC package:
a first memory comprising one or more memory units;
execution logic for executing a sequence of instructions, the execution logic being arranged so as to always begin by fetching and executing the sequence of instructions from the first memory upon start-up of the processor;
a first flag hardwired to begin as asserted when the processor starts-up and to be automatically de-asserted when the execution logic switches to executing any instruction of the sequence from any second memory instead of the first memory;
a second flag; and
termination circuitry hardwired to halt the execution the sequence of instructions by the execution logic if the first flag is de-asserted when the second flag is asserted.

2. The processor of claim 1, wherein the first flag cannot be re-asserted by software.

3. The processor of claim wherein the first flag can only be re-asserted by restarting the processor.

4. The processor of claim 1, wherein the second flag is hardwired to begin as de-asserted upon start-up of the processor and to be assertable by software fetched only from the first memory when the first flag is asserted.

5. The processor of claim 4, wherein one or both of:
the second flag cannot be de-asserted by software, and/or
the second flag can only be de-asserted by re-starting the processor.

6. (canceled)

7. The processor of claim 4, wherein the execution logic is configured to execute machine code instructions being instances of instruction types in a predefined instruction set of the processor, and wherein the instruction set includes a dedicated instruction for asserting the second flag, the dedicated instruction being only available when executing instructions from the first memory and being the only way to assert the second flag.

8. The processor of claim 1, wherein the execution logic comprises respective hardware support for each of a plurality of threads, the respective hardware support comprising at least a respective context arranged to represent a program state of a respective thread, said sequence of instructions being a first one of the threads.

9. The processor of claim 8, wherein the execution logic comprises a common execution unit for the threads, and interleaving circuitry operable to interleave the threads through the common execution unit.

10. The processor of claim 8, wherein the execution logic comprises a plurality of execution units each operable to execute a respective one of the threads.

11. The processor of claim 8, wherein:
the processor comprises a respective instance of the first flag and a respective instance of the second flag associated with each context; and
the termination circuitry is configured so as, if any context has the respective first flag de-asserted when the respective second flag is asserted, to automatically halt execution of the respective thread represented by the respective context.

12. : The processor of claim 11, wherein the termination circuitry is configured so as:
when the thread of a first of said contexts, that has the respective first flag de-asserted, modifies a state of the thread represented by a second of said contexts that has the respective first flag asserted, to automatically de-assert the respective first flag of the second context.

13. The processor of claim 8, wherein the termination circuitry is configured so as when one of the threads is halted due to the respective first flag being de-asserted when the respective second flag is asserted, to allow execution of one, some or all other of the threads to continue.

14. The processor of claim 8, wherein the termination circuitry is configured so as when any of the threads is halted due to the respective first flag being de-asserted when the respective second flag is asserted, all execution across the whole processor is halted.

15. The processor of claim 8, wherein the processor is programmed with the plurality of threads but only one or some, but not all, of the threads are programmed to assert the respective second flag.

16. The processor of claim 8, configured such that when an existing one of said threads creates a new one of said threads, then:
if the existing thread has the respective first flag asserted then the new thread will begin with its respective first flag asserted, but otherwise the respective first flag of the new thread will be de-asserted.

17. The processor of claim 16, configured such that:
if the existing thread has the respective first flag asserted and the respective second flag asserted, then the new thread will have its respective second flag asserted, but otherwise the respective second flag of the new thread will begin de-asserted.

18. The processor of claim 1, wherein the first flag is arranged to be readable by software.

19. The processor of claim 1, wherein either:
i) the first memory consists of ROM, OTP memory, tamperproof RAM and/or other tamperproof rewriteable memory, and
the second memory comprises RAM, EEPROM or other rewriteable memory; or
ii) the first memory comprises a protected area of rewriteable memory in a memory unit and the second memory comprises an unprotected area of rewritable memory in the same memory unit.

20-21. (canceled)

22. The processor of claim 1, wherein the first flag is also hardwired so as one or both of:
to be automatically de-asserted if an instruction of the sequence loads data from an untrusted memory or area of memory; and/or
to be automatically de-asserted if an instruction of the sequence stores data to an untrusted memory or area of memory.

23-25. (canceled)

26. A method comprising providing different instances of the processor of claim 1, wherein on one of the instances of the processor one or more of the instructions fetched from the first memory are programmed to assert the second flag, and in another of the instances of the processor no instructions are programmed to assert the second flag.
